(19) United States
(12) Patent Application Publication
(10) Pub. No.: US 2014/0374382 A1
(43) Pub. Date: Dec. 25, 2014

(54) Arc-Jump Circuit Breaker And Method Of Circuit Breaking

(71) Applicants: Rudolf Gati, Niederrohrdorf (CH); Arthouros Iordanidis, Baden (CH); Felix Greuter, Baden-Rutihof (CH); Markus Abplanalp, Baden Dattwill (CH)

(72) Inventors: Rudolf Gati, Niederrohrdorf (CH); Arthouros Iordanidis, Baden (CH); Felix Greuter, Baden-Rutihof (CH); Markus Abplanalp, Baden Dattwill (CH)

(21) Appl. No.: 14/479,974

(22) Filed: Sep. 8, 2014

Related U.S. Application Data
(63) Continuation of application No. PCT/EP2012/053804, filed on Mar. 6, 2012.

(51) Int. Cl. H01H 9/38; H01H 9/44; H01H 9/42

(52) U.S. Cl. CPC H01H 9/38; H01H 9/42; H01H 9/443
USPC 218/8

(57) ABSTRACT

A circuit breaker for breaking an AC current, including a pair of breaker contact members with a first breaker contact member and a second breaker contact member, wherein the pair of breaker contact members is separable, whereby an arc carrying an arcing current develops between the breaker contact members; an arcing contact member configured for letting an arc root of the arc jump from the second breaker contact member to the arcing contact member, whereby the arcing current is commuted from the second breaker contact member to the arcing contact member, the commuted arcing current having a first direction; and a current-rectifying element electrically connected to the arcing contact member and configured for passing the commuted arcing current having the first direction, and for blocking a current having a second direction opposite to the first direction.

### FIELD OF THE INVENTION

Aspects of the invention relate to a circuit breaker, especially one for breaking an AC current, and to a method of breaking an electrical circuit, in particular, an AC current flowing through the circuit, by such a circuit breaker.

### BACKGROUND OF THE INVENTION

For protecting circuits from over-currents, circuit breakers are provided which are triggered and opened in the case of a fault situation, thereby interrupting a main current path in the circuit. The circuit breakers are generally provided as mechanical switches. These switches typically have at least two contacts (nominal contacts), which are initially pressed against each other and conduct the current in normal operation. Herein, nominal contacts are defined as separable contacts which conduct an operating current, or at least a major part of the operating current (over 50%), flowing through the switch when the switch is closed and in normal operation.

In case of a fault, a mechanism which separates the two contacts of the switch is triggered. If current is flowing at this instant, it will continue to flow through the opened gap by heating up the contacts and/or insulating gas surrounding the contacts, until the material of the contacts and/or the gas is ionized and becomes conductive, i.e. a plasma state is reached. Thereby an electric arc is created. The arc can only be sustained, if the current, and with it the electric heating of the plasma, is sufficiently high. This is typically the case for fault current conditions.

In order to break the current, the arc has to be extinguished. This can be achieved by decreasing the current and with it the heating power below a certain threshold, below which the heating is not sufficient to sustain the arc. The plasma cools down and loses its conductivity. Such a situation can typically only be reached around a current zero crossing of the AC current, as with vanishing current the heating of the plasma disappears, as well.

Hence, conventional circuit breakers are switching off the current at a zero crossing. However, a further limiting factor for the performance of the circuit breaker has to be considered: Around current zero the current profile can be approximately described, in a current-over-time diagram, by a linear ramp. For a low steepness (slow increase of the current after the zero-crossing) of the current the cooling power is larger than the heating for a long period of time, and is hence sufficient to increase the resistance of the arc and with it to switch off the current. On the other hand, if the steepness of the linear ramp is increased successively (towards higher increase of the current after the zero-crossing), at some steepness the cooling period will not be sufficiently long anymore and the arc will reignite after the zero-crossing. For a variety of circuit breakers this is one of the main limiting factors of the performance.

Thus, there is a need for a circuit breaker that reduces the risk of re-ignition, even if the current increase of the current after the zero-crossing is relatively high.

### SUMMARY OF THE INVENTION

In view of the above, a circuit breaker and a method of breaking an electrical circuit according to the independent claims are provided. Further advantages, features, aspects and details that can be combined with embodiments described herein are evident from the dependent claims, the description and the drawings.

According to an aspect, a circuit breaker for breaking an AC current is provided. The circuit breaker comprises a pair of breaker contact members with a first breaker contact member and a second breaker contact member, wherein the pair of breaker contact members is separable, whereby an arc carrying an arcing current develops between the first and second breaker contact members; an arcing contact member configured for letting an arc root of the arc jump from the second breaker contact member to the arcing contact member, whereby the arcing current is commuted from the second breaker contact member to the arcing contact member, the commuted arcing current having a first direction; and a current-rectifying element electrically connected to the arcing contact member and configured for passing the commuted arcing current having the first direction, and for blocking a current having a second direction opposite to the first direction.

According to a further aspect, a method of breaking an electrical AC circuit using a circuit breaker is provided. The circuit breaker comprises a pair of breaker contact members with a first breaker contact member and a second breaker contact member, an arcing contact member, and a current-rectifying element. The method comprises separating the pair of breaker contact members, whereby an arc develops between the first and second breaker contact members, the arc carrying an arcing current between the first and second breaker contact members; causing an arc root to jump from the second breaker contact member to the arcing contact member, whereby the arcing current is commuted from the second breaker contact member to the arcing contact member, the commuted arcing current having a first direction; passing the commuted arcing current through a current-rectifying element electrically connected to the arcing contact member; and, when the arcing current undergoes a zero-crossing to reverse the direction of the commuted arcing current, blocking the arcing current with the current-rectifying element.

An advantage is that the current-rectifying element lets the arcing current pass through only as long as the arcing current has the first direction. After the current then undergoes a zero-crossing and consequently changes direction, to have the second direction, the current is blocked by the rectifying element. Thus, after the zero-crossing, the current path to the arcing contact member via the current-rectifying element is blocked and the current cannot reignite in this manner.

### BRIEF DESCRIPTION OF THE DRAWINGS

More details of aspects and embodiments of the invention are described in the following with reference to the figures, wherein

FIGS. 1a to 1c are schematic views of a circuit breaker according to a first embodiment of the invention in a closed configuration (FIG. 1a) and during the circuit-breaking (FIGS. 1b and 1c);

FIGS. 2a to 2c are schematic views of a circuit breaker according to a second embodiment of the invention in a closed configuration (FIG. 2a) and during the circuit-breaking (FIGS. 2b and 2c);

FIG. 3 is a schematic view of a circuit breaker according to a third embodiment of the invention;

FIG. 4 is a schematic view of a circuit breaker according to a fourth embodiment of the invention; and

FIGS. 5a to 5d are schematic views of a circuit breaker according to a fifth embodiment of the invention in a closed configuration (FIG. 5a) and during the circuit-breaking (FIGS. 5b to 5d).

### DETAILED DESCRIPTION OF THE INVENTION

Reference will now be made in detail to the various embodiments, examples of which are illustrated in the Figures. Each example is provided by way of explanation and is not meant as a limitation. Herein, features illustrated or described as part of one embodiment can be used on or in conjunction with any other embodiment to yield yet a further embodiment. It is intended that the present disclosure includes such modifications and variations.

Before describing the Figures, some aspects and embodiments of the invention will be described independently of the Figures.
According to an aspect, the circuit breaker for breaking an AC current comprises:
a pair of breaker contact members with a first breaker contact member and a second breaker contact member. The pair of breaker contact members is separable, i.e. the first and second breaker contact members are separable from each other, for interrupting a current, whereby an arc carrying an arcing current develops between the first and second breaker contact members;
an arcing contact member configured for letting an arc root of the arc jump from the second breaker contact member to the arcing contact member, whereby the arcing current is commuted from the second breaker contact member to the arcing contact member, the commuted arcing current having a first direction; and
a current-rectifying element electrically connected to the arcing contact member and configured for passing (i.e. letting pass through) the commuted arcing current having the first direction, and for blocking a current having a second direction opposite to the first direction.

As an advantageous aspect, The first current-rectifying element is configured for letting the arcing current pass through, as long as the arcing current has the first direction after having jumped to the arcing contact member, and is configured for blocking the current after it undergoes a zero-crossing to have the second direction. Here, undergoing a zero-crossing includes the approaching of what would be a zero-crossing without actually achieving the zero-crossing of the current because the reverse current is blocked. The zero-crossing is nevertheless real and can be observed, e.g., in terms of the voltage.

As an advantageous aspect, the circuit breaker is adapted such that the current paths for the current and, correspondingly, the most favourable paths for the arc, are different depending on the direction of the current.

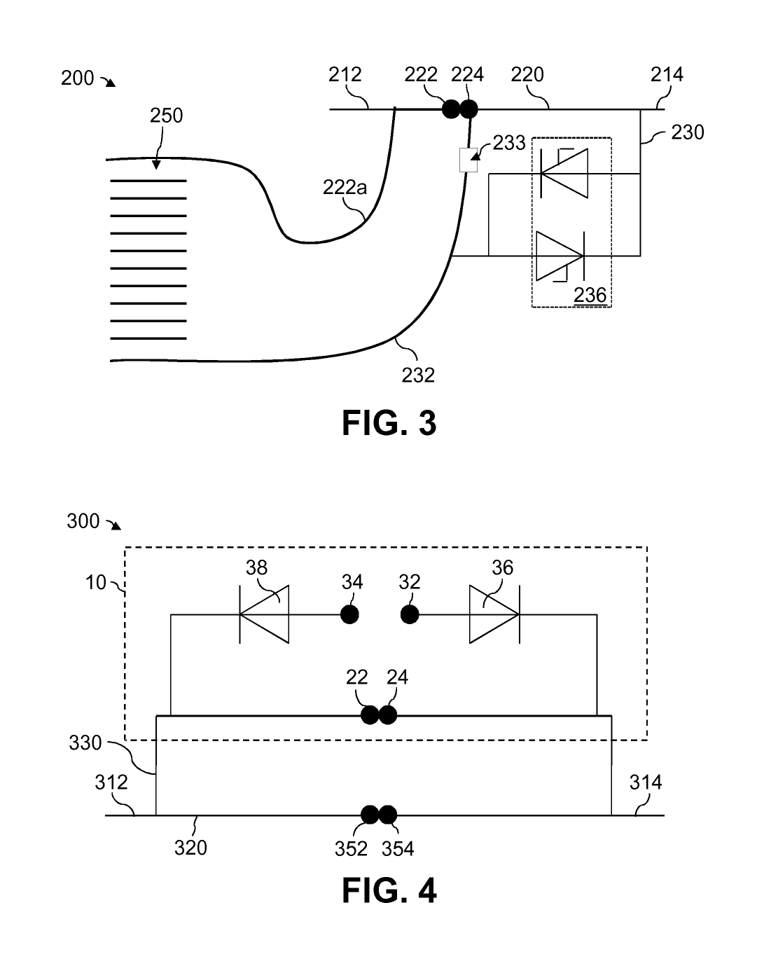

Herein, the breaker contact members and arcing contact elements generally have a respective single conductive surface. The breaker contact members and arcing contact elements may be spatially extended and have a spatially extended surface which along the arc may travel. Such a case is illustrated, e.g., in FIG. 3 (surface 222a) to be described in more detail below. Even if the arc travels along a surface in such a manner, this is not considered as having undergone a jump. Herein, a jump of the arc is generally defined by the arc root crossing across an insulated (non-electrically-conductive) region.

Hence, according to an aspect of the invention, an (electrically) insulated region is provided between the arcing contact member and the second breaker contact member, such that the arc jumps from the second breaker contact member to the arcing contact member via the insulated region. The insulated region can, for example, be an insulating gap or a dielectric material. As a further aspect, the arcing contact member and the second breaker contact member can be electrically insulated from one another on the arc-facing side of the current-rectifying element.

As a further aspect, the arcing contact member and the second breaker contact member are electrically connected via the current-rectifying element.

According to a further aspect, the current-rectifying element is provided in a branch which is electrically connected in parallel to the breaker current, and/or electrically connected in parallel to the nominal current path. Thereby, advantageously, the current-rectifying element is provided in a branch which does not carry the main portion of the nominal current during normal operation, but is connected parallel thereto. Thereby, electrical losses due to the current-rectifying element can be avoided. Such losses would reduce the efficiency during normal operation, and would possibly necessitate additional cooling of the current-rectifying element. By providing the current-rectifying element in a branch which is separate from the main nominal-current-carrying branch, these disadvantages can be avoided.

The above, and any other, aspects described for the (first) arcing contact member and the second breaker contact member may likewise also apply to the second arcing contact member (if present) and the first breaker contact member. For example, if present, the second arcing contact member and the first breaker contact member may electrically be connected via the second current-rectifying element.

According to a further aspect, the breaker contact members are moveable relatively to one another for separating and/or connecting the breaker contact members from and/or to one another. According to a further aspect, the arcing contact member(s) is or are stationary.

According to a further aspect, the circuit breaker further comprises an arc-moving arrangement for moving the arc root from the second breaker contact member to the arcing contact member. For example, the arc-moving arrangement may comprise a magnetic field generator for generating a magnetic field moving the arc root to the arcing contact member by a Lorentz force. Alternatively or additionally, the arc-moving arrangement may comprise a contact-moving device for moving at least one of the first breaker contact member, the second breaker contact member and the arcing contact member in such a manner that the distance between the first breaker contact member and the arcing contact member becomes shorter than the distance between the first breaker contact member and the second breaker contact member. Other examples of an arc-moving arrangement include a pressure-gradient-generating device for generating a pressure gradient pushing the arc towards the arcing contact member; a gas-blowing arrangement for blowing a gas stream onto the arc, the gas stream pushing the arc towards the arcing contact member; and a high-voltage discharge arrangement coupled to the arcing contact member for inducing a high-voltage discharge at the arcing contact member.

Also, alternatively or additionally, the arc-moving arrangement may be configured to move the arc root to the arcing contact member at a time less than 2 ms before the arcing current undergoes a zero-crossing. This can be achieved, e.g., by a synchronizing arrangement that synchronizes the movement of the breaker contact member(s) and the arcing contact member(s) with the phase of the AC current.

According to a further aspect, the first breaker contact member is configured such that when the arc root jumps from the second breaker contact member to the arcing contact member, another arc root at another end of the arc stays at the first breaker contact member such that the commuted arcing current flows between the first breaker contact member and the arcing contact member.

According to a further aspect, the circuit breaker further comprises a second arcing contact member configured such that when the arcing current has the second direction, a second arc root of the arc jumps from the first breaker contact member to the second arcing contact member, whereby the arcing current is commuted from the first breaker contact member to the second arcing contact member while the first arc root remains at the second breaker contact member; and a second current-rectifying element electrically connected to the second arcing contact member and configured for passing the commuted arcing current having the second direction, and for blocking a current having the first direction. With these modifications, any description of the (first) arcing contact member and the (first) current-rectifying element herein may also apply to the second arcing contact member and the second current-rectifying element.

According to a further aspect, the current-rectifying element comprises (or is) a solid-state semiconductor device, e.g., a diode or transistor (e.g., a thyristor). In this case, the current-rectifying element's forward direction may be the first direction and the reverse direction may be the second direction. If present, the second current-rectifying element can comprise (or be) a solid-state semiconductor device, e.g., a diode or transistor, for which the forward direction is the second direction and the reverse direction is the first direction. The (first and/or second) current-rectifying element may, in particular, comprise a pair of thyristors connected in parallel and having opposite forward directions.

The current-rectifying element (generally comprising a semiconductor device) may include additional elements. For example, it might include a system or device for limiting the voltage across the semiconductor device, such as a parallel resistor or capacitance, or in case of the semiconductor device being a thyristor, it may comprise a gate switch bringing the thyristor into blocking mode only if the arcing current is below a predetermined current threshold.

According to a further aspect, the circuit breaker further comprises an arcing chamber with splitter plates, wherein the arcing contact member is arranged such that the commuted arc traverses the arcing chamber and is split by the splitter plates.

According to a further aspect, the circuit breaker further comprises a pair of nominal contacts with a first nominal contact member and a second nominal contact member electrically connected in parallel to the pair of breaker contact members. The pair of nominal contact members can be separable from each other prior to separation of the pair of breaker contact members, for commuting the current to the pair of breaker contact members.

According to a further aspect, the circuit breaker further comprises a cooling arrangement for cooling a gap which emerges between the pair of breaker contact members after separation of the pair of breaker contact members. The cooling arrangement may include a gas nozzle system for blowing an arc extinguishing gas to the gap.

According to a further aspect, a method of breaking an electrical AC circuit by a circuit breaker is provided. The circuit breaker comprises a pair of breaker contact members with a first breaker contact member and a second breaker contact member, an arcing contact member, and a current-rectifying element. The method comprises:
separating the pair of breaker contact members, i.e. separating the first and second breaker contact members from each other, whereby an arc develops between the pair of breaker contact members, i.e. between the first and second contact breaker contact member, the arc carrying an arcing current between the pair of breaker contact members;
causing an arc root to jump from the second breaker contact member to the arcing contact member, whereby the arcing current is commuted from the second breaker contact member to the arcing contact member, the commuted arcing current having a first direction;
passing the commuted arcing current through a current-rectifying element electrically connected to the arcing contact member;
when the arcing current undergoes a zero-crossing to reverse the direction of the commuted arcing current to be a second direction opposite to the first direction, blocking the arcing current with the current-rectifying element.

In particular, the circuit breaker of the method may be in accordance with any other aspect or embodiment described herein.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment, as well.

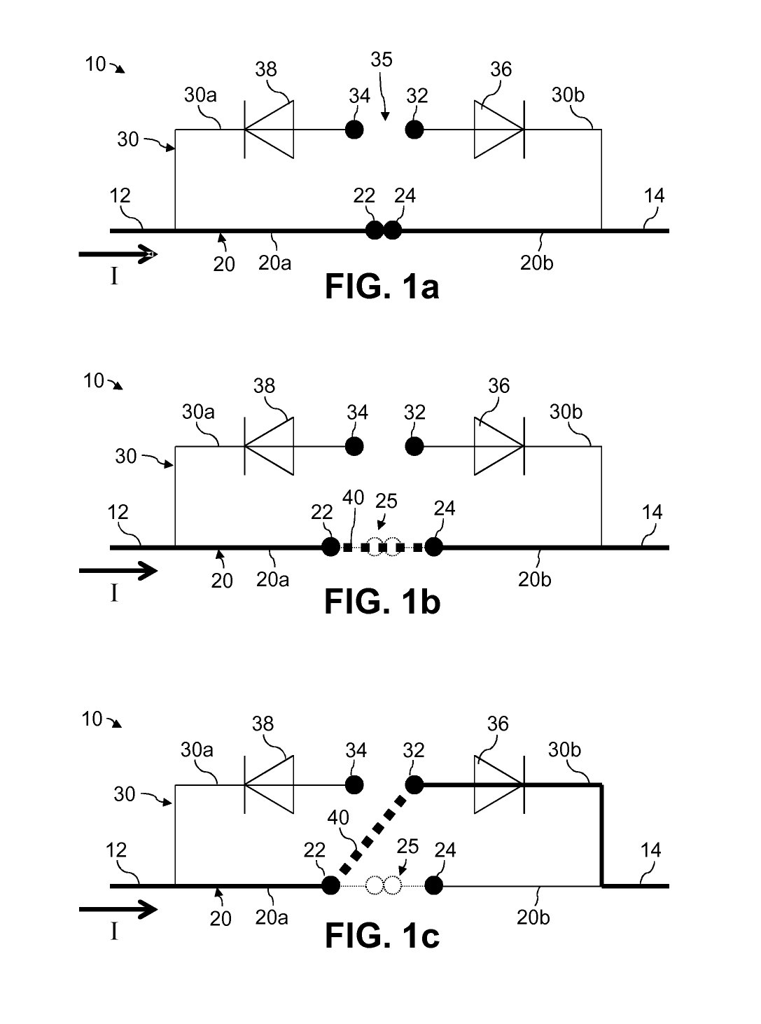

FIGS. 1a to 1c are schematic views of a circuit breaker 10 according to a first embodiment of the invention. The circuit breaker 10 has a pair of breaker contact members 22, 24. The first breaker contact member 22 is connected to a first terminal 12 via line 20a, and the second breaker contact member 24 is connected to a first second terminal 14 via line 20b.

The circuit breaker 10 further has a pair of arcing contact members 32, 34. The arcing contact members 32, 34 are separated from each other by a gap. The first arcing member 32 is connected to the second terminal 14 via a current-rectifying element 36 and line 30b. Thereby, the first arcing member 32 is connected to the second breaker contact member 24 via the current-rectifying element 36 (and lines 30b, 20b). Likewise, the second arcing member 34 is connected to the first terminal 12, via the further or second current-rectifying element 38 and line 30a.

FIG. 1a shows the circuit breaker in a closed configuration. Here, the breaker contact members 22, 24 are in contact with one another to establish an electrical path between the terminals 12 and 14 via the line 20a, the breaker contact members 22, 24, and the line 20b. The breaker contact members 22, 24 are nominal contact members, i.e. the path they establish in the closed configuration is a nominal current path, along which an operating current, or at least a major part of the operating current (over 50%), is directed. The operating current is the current flowing through the switch when the switch is closed and in normal operation. The current 20 flowing through the switch is indicated by a thick line and may be the normal operating current described above, or some fault current such as a short-circuit current. The direction of the current 20 is indicated by the arrow “I”.

The circuit breaker 10 may include other parts which are omitted in FIG. 1a. The circuit breaker 10 may be of any type which has two separable breaker contact members, such as for example a gas-insulated or vacuum circuit breaker. In particular, the circuit breaker may include a gas-insulated housing, an arc-extinguishing nozzle system and/or any other elements commonly used in circuit breakers with two separable contact members.

For breaking the current 20, either one or both of the breaker contact members 22, 24 is or are moved such that the breaker contact members 22, 24 are separated from one another. The resulting configuration is shown in FIG. 1b. Therein, a gap 25 has developed between the breaker contact members 22, 24. As described above, even after breaking contact members 22, 24 have been separated from one another, the current 20, now also referred to as arcing current, continues to flow through the opened gap 25 via an electric arc 40. The arc is created in the gap 25, and extends between a first arc root at the first breaking contact members 22 and a second arc root at the second breaking contact members 24.

After creation of the arc 40 shown in FIG. 1b, its second arc root is caused to jump from the second breaker contact member 24 to the arcing contact member 32. Thereby, the second arc root jumps across an insulated gap which is arranged between the arcing contact member 32 and the second breaker contact member 24.

The jumping of the current is caused by an arc-moving arrangement which moves (causes to jump) the arc root from the second breaker contact member 24 to the arcing contact member 32. The arc-moving arrangement is not shown in detail in FIGS. 1a to 1c and may be implemented in a number of ways.

For example, the arc-moving arrangement may include a magnetic field generator for generating a magnetic field moving the arc root to the arcing contact member 32 by a Lorentz force. The magnetic field may be generated by the arcing current itself. To this purpose, the first and/or second breaker contact member 22 and/or 24 may include slits, due to which the arcing current is forced to flow along a suitable path after separation of the breaker contact members 22 and 24. This current generates the magnetic field, and by suitable choice of the current's path direction(s) the magnetic field can be shaped such that it forces the arc towards the arcing contact member 32.

In another example, the arc may be moved due to the electrical field at the arcing contact attracting the arc. This electrical field can be realized by the arcing contact member 32 being, at some point during the opening of the circuit breaker, closer to and/or less shielded from the first breaker contact member 22 than the second breaker contact member 24. Then, due to the higher field strength at the arcing contact member 32, the arc jumps to the arcing contact member. Hence, the arc-moving arrangement may include a contact-moving device for moving the first breaker contact member 22, the second breaker contact member 24 and/or the arcing contact member 32 in such a manner that the above-described conditions are realized at some time during the opening of the circuit breaker. For example, the distance 22-32 (i.e. distance between the first breaker contact member 22 and the arcing contact member 32) may at first be larger than the distance 22-24 (i.e. distance between the first breaker contact member 22 and the second breaker contact member 24), but the contact-moving device may move the contacts in such a manner that at some point after separation of the contact members 22 and 24, the distance 22-32 becomes shorter than the distance 22-24. Also, the arcing contact member 32 may be shaped with a higher curvature than the second breaker contact member 24, and/or may be arranged to partially shield the second breaker contact member 24 after separation of the contact members 22 and 24.

As a further example of an arc-moving arrangement, a pressure-gradient-generating device for generating a pressure gradient pushing the arc towards the arcing contact member may be provided. The pressure-gradient-generating device may be realized by an ablating wall which is arranged such as to be ablated by the arc when the arc burns between the first and second breaker contact members, thereby generating the pressure gradient.

As a further example, a gas-blowing arrangement for blowing a gas stream onto the arc may be provided, such that the gas stream pushes the arc towards the arcing contact member. The gas-blowing arrangement may be realized by a nozzle system which can, for example, be coupled to a self-blast type heating chamber and/or to a pressurized-gas reservoir. The gas-blowing arrangement may, in an example, include a chimney-like geometry with a chimney chamber having openings at the bottom and the top.

Alternatively, the arc may be moved by a high-voltage discharge arrangement coupled to the arcing contact member for inducing a high-voltage discharge at the arcing contact member. The high-voltage discharge then generates an electrical field sufficient for attracting the arc to the arcing contact member, and/or for igniting—and thereby moving—the arc at the arcing contact member. Also, the arc-moving arrangement may include a combination of various examples described herein.

The result of the jump of the arc is shown in FIG. 1c: The arc 40 extends between the first breaking contact member 22 (at which the first arc root is still located) and the arcing contact member 32 (to which the second arc root has jumped, i.e. has moved spatially discontinuously). Correspondingly, the arcing current 20 is commuted from the second breaker contact member 24 to the arcing contact member 32.

The overall flow of the commuted current 20, after the jump of the arc 40, is shown as a fat line in FIG. 1c: The current flows from the terminal 12 via line 20a to the first breaker contact member 22 (as before). Then the commuted current flows across the arc 40 to the arcing contact member 32, and then via the current-rectifying element 36 and the line 30b to the terminal 14.

The FIGS. 1a to 1c show states within a single AC half-cycle, within which the current does not undergo a zero-crossing. Thus, in all FIGS. 1a to 1c, the current is flowing in the same direction, namely from left to right, as indicated by the arrow I. This direction is also referred to as the first direction. At some time after the state shown in FIG. 1c, the AC current undergoes a zero-crossing and changes direction, i.e. the current is then directed in a second direction opposite to the first direction (from right to left).

At the zero-crossing the arc is extinguished in a known manner, either by not being sustained because of the temporarily low current, or possibly using an additional arc-extinguishing system (not shown in FIGS. 1a to 1c), such as a nozzle system for causing a cooling gas to blow onto the arc, and/or arc-splitting plates, such as shown in FIG. 3. However, there may nevertheless remain ionized gas or other charge carriers at the location of the arc, and in the previously known switches these remaining charge carriers caused a risk of arc reignition after the zero-crossing, as described above.

In contrast, in the breaker of FIG. 1c the risk of reignition is reduced as follows: After the zero-crossing, when the current has changed direction to have the second direction, the current-rectifying element 36 blocks the current: The current-rectifying element 36 assures that the arc does not reignite at the arcing contact 32. Hence, the current path 20 of FIG. 1c is not available after the current has changed direction, and the current is prevented from flowing through the path it took before.

Instead, with the current having the second direction, the only place left for an arc to develop would be at the second breaker contact 24. However, because of the previous arc jump (transition from FIG. 1b to FIG. 1c), the gas at the gap between the breaker contacts 22, 24, and especially near the contact 24, has had additional time to cool down while the arc has been burning at a different place (at the arcing contact 32). Thus, the gas is already cold and there is no significant amount of charge carriers left in the region of the second breaker contact 24. Hence, the risk of arc reignition is significantly reduced.

Thus, due to the arcing contact member 32 in combination with the current-rectifying element 36, an additional time is obtained, during which the air gap between the breaker contact members 22, 24 can cool down while the arc is burning elsewhere, for example at the arcing contact member 32. Also, reignition at the arcing contact member 32 is suppressed by the current-rectifying element 36. Hence, the effect of the arcing contact member 32 in combination with the current-rectifying element 36 is that the breaking performance of the circuit breaker is improved.

The second arcing contact member 34 and second current-rectifying element 38 are inactive for the circuit breaking shown in FIGS. 1a to 1c. These elements 34, 38 only play a role for breaking a current in the other half-phase of the AC current, when the initial current flows from right to left, i.e. in the opposite direction to the current shown in FIGS. 1a to 1c. In this case, a horizontally mirrored version of the above-described breaking operation takes place, in which the first and second arcing contact members 32, 34; the first and second breaker contact members 22, 24; and the first and second current-rectifying elements 36, 38 are interchanged, respectively.

In an alternative embodiment, the second arcing contact member 34, the second current-rectifying element 38 and the second line 30a can also be omitted, thereby saving cost. In this case, the advantageously improved breaking operation can only be performed when the current is flowing in the direction shown in FIGS. 1a to 1c. If the current is flowing in the opposite direction, one can wait for an additional half-cycle until the current has the appropriate direction.

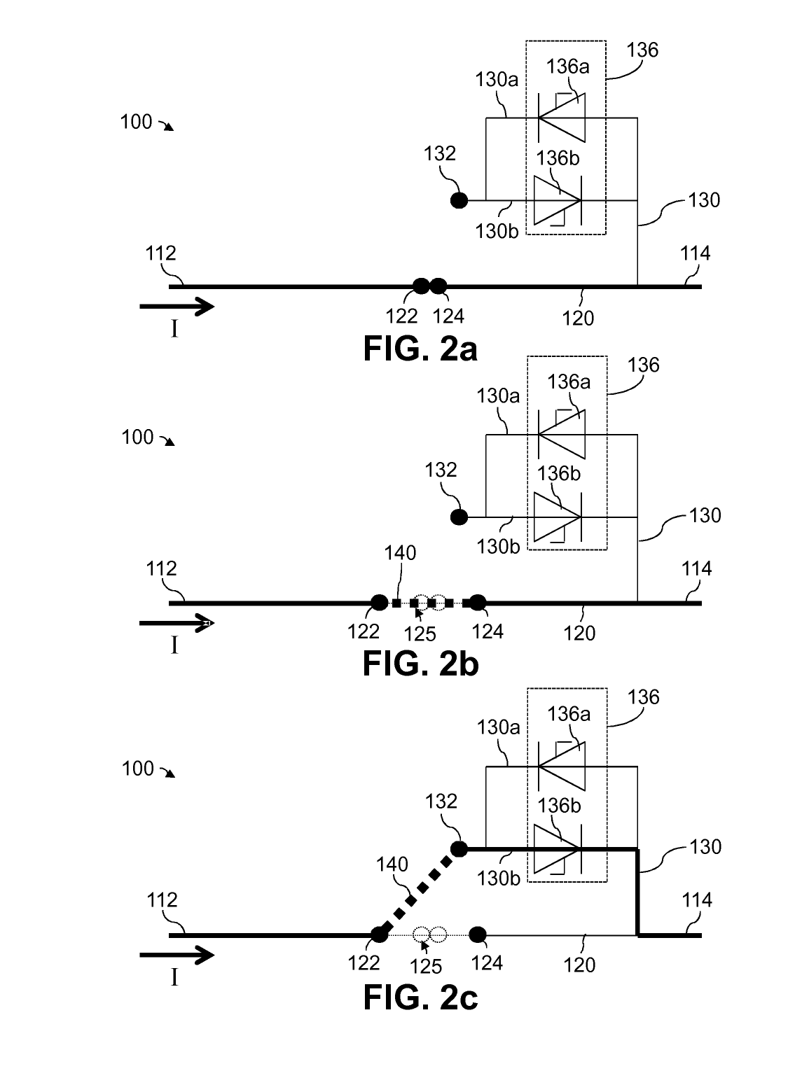

FIGS. 2a to 2c are schematic views of a circuit breaker 100 according to a second embodiment of the invention. The circuit breaker 100 has a pair of breaker contact members 122, 124 connected to a first or second terminal 112, 114, respectively, in the same manner as in the embodiment of FIGS. 1a to 1c. The circuit breaker 100 further has an arcing contact member 132 which corresponds to the arcing contact member 32 of FIGS. 1a to 1c. The arcing member 132 is connected to the second terminal 114 via a current-rectifying element 136 and line 130, which correspond to the elements 36 and 30b of FIGS. 1a to 1c, respectively. Unless indicated or clear otherwise, the description of the members of FIGS. 1a to 1c also applies to the corresponding members of FIGS. 2a to 2c.

In FIGS. 2a to 2c, the current-rectifying element 136 is realized by a pair of thyristors 136a, 136b. The thyristors 136a, 136b are anti-parallel, i.e. they are connected in parallel and have mutually opposite forward directions.

During nominal operation, the thyristors 136a, 136b are deactivated, such that they—and, consequently, the current-rectifying element 136—do not allow the current to pass through. Instead, the only path available for the current is through the nominal current path 120, i.e. through the breaker contact elements 122, 124.

In case of a fault or an over-current, the device is tripped and the breaker contact members 122, 124 are separated from one another, as shown in FIG. 2b, in the same manner as described above with respect to FIG. 1b. In particular, an electric arc 140 is created between the breaker contact members 122, 124.

However, for the time being, the thyristors 136a, 136b are still not activated yet. Consequently, no current can flow through them, and therefore the arc is forced to continue burning between the breaker contact elements 122, 124, as is shown in FIG. 2b. In this manner, an arc jump can be suppressed for some time, even if the breaker 100 has an arc jump mechanism as described above with respect to FIGS. 1a to 1c.

For example, it may be advantageous to wait with the arc jump until the current is approaching the zero crossing (e.g. below a certain threshold current value). To this purpose, the breaker 100 comprises a current measurement device and a control device that is configured to activate the thyristors 136a, 136b only when the magnitude of the measured (and possibly processed, e.g. smoothened or fitted) current signal has fallen below a threshold value. This allows avoiding a breakdown of the thyristors 136a, 136b reliably, without need to dimension the thyristors to withstand a full rated current of the breaker.

When the appropriate time for the arc to jump has come, the thyristors 136a, 136b are activated by applying a trigger signal (e.g. a current or voltage pulse) to their gates. The trigger signal causes the forward-biased one of the thyristors 136a, 136b (here: thyristor 136b) to become conductive, while it has no effect on the reverse-biased thyristor 136a. Alternatively, the trigger signal may be applied only to the forward-biased thyristor 136b.

Thereby, the current-rectifying element 136 becomes conductive for the current I. This allows the second arc root to jump from the second breaker contact member 124 to the arcing contact member 132, as already described with respect to FIGS. 1b and 1c above. The commuted arc is sustained by the current flowing through the current-rectifying element 136. The resulting configuration is shown in FIG. 2c: Therein, the current flow, indicated by a thick line, is analogous to the current flow of FIG. 1c.

Sometime after the state shown in FIG. 2c is achieved, the AC current undergoes a zero-crossing and changes direction (from the first direction to the opposite second direction). At the zero-crossing the arc is extinguished. Also, after the zero-crossing, when the current has changed direction to have the second direction, the thyristor 136b becomes reverse-biased and therefore stops being conductive. As a result, the current-rectifying element 136 now blocks the current. As a consequence, the current is prevented from taking the path (thick line) of FIG. 2c it took before. Thus, in the same manner as was described with respect to FIG. 1c, the only place left for an arc to develop would be at the second breaker contact 124, at which the gas has already cooled down.

The initially reverse-biased thyristor 136a is inactive for the circuit breaking shown in FIGS. 2a to 2c. This thyristor only plays a role for breaking a current in the other half-phase of the AC current, when the initial current flows in the opposite direction of the current shown in FIGS. 2a to 2c. In this case, the roles of thyristors 136a and 136b are interchanged.

The second embodiment is actively controlled by triggering the thyristors 136a and 136b. This may require a more elaborate control in comparison to the first embodiment. As an advantage, the active triggering allows a direct control of the time at which the arc jumps to the arcing contact 132. For example, the arc may be caused to jump at a time less than 2 ms before the arcing current undergoes a zero-crossing. As discussed above, this may allow a reliable operation even with thyristors rated below the maximum rated current of the breaker.

In a variation of the second embodiment, only one of the thyristors 136a and 136b needs to be provided, the other one being omitted, thereby saving cost. In this case, the advantageously improved breaking operation can only be performed when the current is flowing in one predetermined direction, say, the first direction. If the current is flowing in the opposite direction, one can wait for an additional half-cycle until the current has the appropriate direction.

In yet a further variation of the second embodiment or its above variation, the thyristor(s) 136a and/or 136b can be replaced by other transistor device(s), such as one or more IGBTs. In this case, the transistor devices may not automatically become inactive (non-conductive) when the current changes direction, but may need to be controlled to become inactive, e.g. by a control device which stops applying a gate voltage to the transistor device(s) when a measured current signal indicates a zero-crossing of the current.

FIG. 3 is a schematic view of a circuit breaker 200 according to a third embodiment of the invention. Its basic setup corresponds to the embodiment of FIGS. 2a to 2c: The circuit breaker 200 has a pair of breaker contact members 222, 224 connected to a first and second terminal 212, 214, respectively; an arcing contact member 232 connected to the second terminal 214 via a current-rectifying element 236 and a line 230. These elements correspond to the elements 122, 124, 112, 114; 132, 114, 136 and 130 of FIGS. 2a to 2c, respectively. Unless indicated otherwise or evident otherwise, the description of the members of FIGS. 2a to 2c and of their function also applies to the corresponding members of FIGS. 3a to 3c. The arcing contact member 232 is separated from the second breaker contact member 224 by an electrically insulating gap (region) 233. Consequently, the arcing contact member 232 and the second breaker contact member 224 are electrically connected only via the current-rectifying element 236.

The first breaker contact member 222 defines an arc guiding surface 222a. Likewise, the second breaker contact member 224 and the arcing contact member 232 (or only one of them, depending on the position of the insulating region 233 between them) define a further, opposing arc guiding surface. These two mutually opposing arc guiding surfaces delimit an arcing chamber, and extend from the breaker contact members 222, 224 at one end of the arcing chamber, to a stack of splitter plates 250 at the other end of the arcing chamber. The arcing contact member 232 and the arc guiding surface 222a, i.e. the two opposing arc guiding surfaces, are arranged such that the arc is caused to travel across the arcing chamber from the breaker contact members 222, 224 to the splitter plates 250 and is subsequently split by the splitter plates 250.

The arc guiding surface 222a forms a single electrically-connected unit with the breaker contact member 222 and is therefore regarded as a part of the breaker contact member. Generally, the breaker contact members and arcing contact members have a respective single conductive surface and may be spatially extended. Thus, even if the arc travels along the surface 222a, the arc is still considered as belonging to the same breaker contact member 222 and as not having undergone a jump. A jump of the arc is across an insulating region 233, e.g. non-conductive gap 233 separating the breaker contact member 224 from the arcing contact member 232.

The breaking operation of the breaker 200 is analogous to the breaking operation described with respect to FIGS. 2a to 2c. In addition, after the arc has jumped to the arcing contact member 232 (corresponding to the situation of FIG. 2c), the arc is caused to travel to the stack of splitter plates 250, where the arc is split. This further enhances the cooling of the arc and, at the same time, the separation of the arc paths before and after the zero-crossing of the current. Hence, the risk of re-ignition is further decreased.

In FIG. 3, the current-rectifying element 236 is shown as a pair of thyristors connected in parallel and having opposite forward directions, i.e. corresponding to the second embodiment. In a variation of this embodiment, any other current-rectifying element described herein may be used, e.g. a single thyristor, or a diode as described with respect to the first embodiment. In the case of a diode, optionally a second diode corresponding to the diode 38 of FIGS. 1a to 1c may be provided.

FIG. 4 is a schematic view of a circuit breaker 300 according to a fourth embodiment of the invention. The circuit breaker 300 includes all elements of the circuit breaker 10 of the first embodiment, a reference is made to the above description thereof. In addition, the circuit breaker 300 further contains a first nominal contact member 352 and a second nominal contact member 354, which are separable from each other.

The pair of nominal contact members 352, 354 are electrically connected in parallel to the pair of breaker contact members 22, 24 (see FIG. 1a). The nominal contact members 352, 354 have a very low resistivity and therefore ensure that losses due to resistivity at the contacts are minimized during normal operation. At this time, the main portion flows along the nominal current path 320 and through the nominal contact members 352, 354.

For opening the circuit breaker 300, the nominal contact members 352, 354 are adapted to be separated from each other before separation of the pair of breaker contact members 22, 24. When the nominal contact members 352, 354 are separated from each other, the current is commuted to the pair of breaker contact members, via the current path 330. Thereafter, the remaining current breaking operation is as described with respect to FIGS. 1a to 1c.

The additional nominal contact members 352, 354 have the advantage that they are not degraded by the arc developing when the breaker is fully opened. Therefore, even if the breaker contacts 22, 24 are slightly degraded by such an arc, the conductivity of the breaker during normal operation is not degraded significantly.

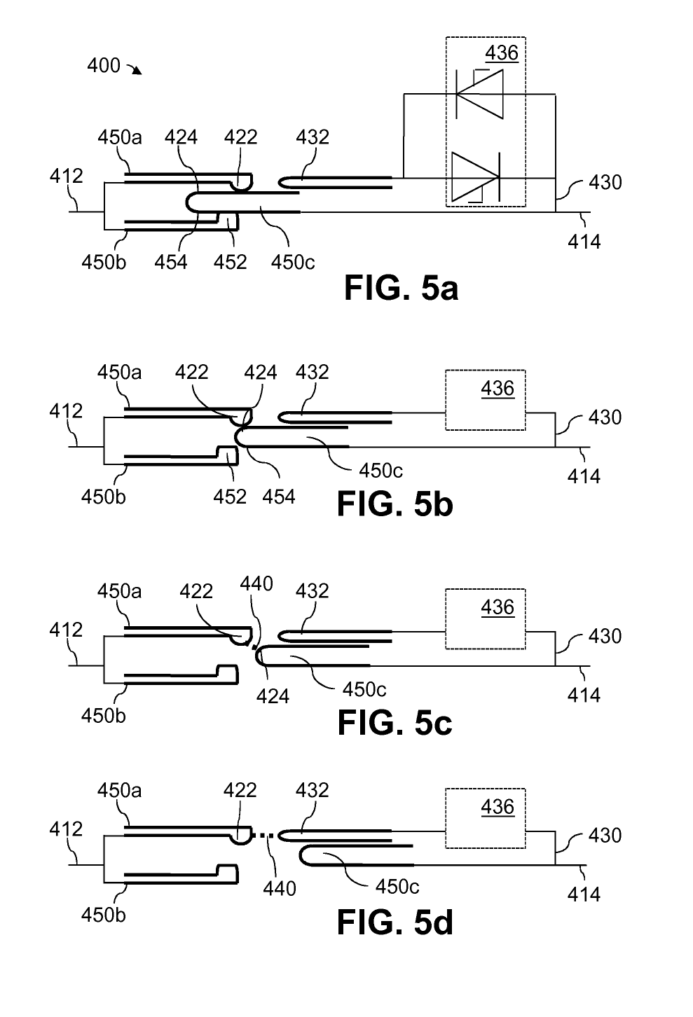

FIGS. 5a to 5d are schematic views of a circuit breaker 400 according to a fifth embodiment of the invention. FIG. 5a shows the circuit breaker 400 in a closed configuration.

The circuit breaker 400 has a pair of fingers 450a and 450b in contact with a first terminal 412, and a contact shaft 450c in contact with a second terminal 414. The contact shaft 450c is movable along an axis (here e.g. horizontally) relative to the pair of fingers 450a and 450b, and is thereby separable from the pair of fingers 450a and 450b.

The finger 450b has a contacting area 452 which is in (separable) contact with a corresponding contact area 454 (lower surface) of the contact shaft 450c. Thereby, the contact areas 452 and 454 are nominal contact members which correspond to the nominal contact members 352, 354 of FIG. 4. Further, the finger 450a has a contacting area 422 which is in (separable) contact with a corresponding contact area 424 (upper surface) of the contact shaft 450c. Thereby, the contact areas 422 and 424 are breaker contact members which correspond to the breaker contact members of the other embodiments, e.g. members 22, 24 of FIGS. 1a to 1c. Further, the breaker 400 has a stationary arcing member 432, which corresponds to the arcing members of the other embodiments, e.g. arcing member 32 of FIGS. 1a to 1c. The arcing member 432 is connected to the second terminal 414 via a current-rectifying element 436 and line 430, which correspond to the elements 36 and 30b of FIGS. 1a to 1c, respectively. Unless indicated or clear otherwise, the description of the members of any other embodiment (e.g. FIGS. 1a to 1c) also applies to the corresponding members of FIG. 5a.

In FIG. 5a, the current-rectifying element 136 comprises a pair of thyristors, in analogy to the embodiment of FIGS. 2a to 2c. However, any other current-rectifying element described herein, such as a diode, can be used instead.

For opening the circuit-breaker 400, the contact shaft 450c is moved away from the fingers 450a and 450b and separated therefrom. During this movement, as is shown in FIG. 5b, the nominal contact members 452 and 454 are separated from each other at a time at which the breaker contact members 422, 424 are still in contact with each other. Consequently, the current is commuted from the nominal contact members 452, 454 to the breaker contact members 422, 424, in the same manner as in the fourth embodiment described above.

Then, as is shown in FIG. 5c, the breaker contact members 422, 424 are also separated from each other, whereby the arc 440 is created between the breaker contact members 422, 424.

Then, as is shown in FIG. 5d, the contact shaft 450c is moved farther away from the fingers 450a and 450b than the arcing contact member 432, such that the contact shaft 450c, and in particular the breaker contact member 424, is at least partially shielded by the arcing contact member 432. Thereby, the field strength at the arcing contact member 432 becomes so high that the right arc root of the arc 440 is caused to jump from the breaker contact member 424 to the arcing contact member 432. After the jump, the arc 440 now extends between the first breaker contact member 422 and the arcing contact member 432. The remaining breaking operation is analogous to the breaking operation described with respect to the previous embodiments.

While the foregoing is directed to embodiments, other and further embodiments may be devised without departing from the basic scope determined by the claims. For example, the arc may be caused to jump by a different movement than the movement of the shaft 450c of FIGS. 5a to 5d. E.g., the arcing contact member 432 may move towards the first breaker contact 422, and/or the arc may be caused by a magnetic field.

Embodiments described herein have in common that the available path for the current, and hence for the arc, depends on the current direction in a way that the available path in a first current direction is different from the available path in the opposite second current direction.

1. A circuit breaker for breaking an AC current, the circuit breaker comprising:
a pair of breaker contact members with a first breaker contact member and a second breaker contact member, wherein the first and second breaker contact members are separable from each other, whereby an arc carrying an arcing current develops between the first and second breaker contact members;
an arcing contact member configured for letting an arc root of the arc jump from the second breaker contact member to the arcing contact member, whereby the arcing current is commuted from the second breaker contact member to the arcing contact member, the commuted arcing current having a first direction; and
a current-rectifying element electrically connected to the arcing contact member and configured for passing the commuted arcing current having the first direction, and for blocking a current having a second direction opposite to the first direction,
the circuit breaker further comprising an arc-moving arrangement for moving the arc root from the second breaker contact member to the arcing contact member, wherein the arc-moving arrangement comprises at least one of the following (i) to (v):
(i) a magnetic field generator for generating a magnetic field moving the arc root to the arcing contact member by a Lorentz force;
(ii) a contact-moving device for moving at least one of the first breaker contact member, the second breaker contact member and the arcing contact member in such a manner that the distance between the first breaker contact member and the arcing contact member becomes shorter than the distance between the first breaker contact member and the second breaker contact member;
(iii) a pressure-gradient-generating device for generating a pressure gradient pushing the arc towards the arcing contact member;
(iv) a gas-blowing arrangement for blowing a gas stream onto the arc, the gas stream pushing the arc towards the arcing contact member;
(v) a high-voltage discharge arrangement coupled to the arcing contact member for inducing a high-voltage discharge at the arcing contact member.

2. The circuit breaker according to claim 1, wherein the arcing contact member is electrically connected to the second breaker contact member via the current-rectifying element.

3. The circuit breaker according to claim 1, comprising an or the arc-moving arrangement for moving the arc root from the second breaker contact member to the arcing contact member, wherein the arc-moving arrangement is configured to move the arc root to the arcing contact member at a time less than 2 ms before the arcing current undergoes a zero-crossing.

4. The circuit breaker according to claim 1, wherein the first breaker contact member is configured such that when the arc root jumps from the second breaker contact member to the arcing contact member, another arc root at another end of the arc stays at the first breaker contact member such that the commuted arcing current flows between the first breaker contact member and the arcing contact member.

5. The circuit breaker according to claim 1, wherein the arcing contact member is a first arcing contact member and the current-rectifying element is a first current-rectifying element, and the arc root is a first arc root, the circuit breaker further comprising
a second arcing contact member configured such that when the arcing current has the second direction, a second arc root of the arc jumps from the first breaker contact member to the second arcing contact member, whereby the arcing current is commuted from the first breaker contact member to the second arcing contact member; and
a second current-rectifying element electrically connected to the second arcing contact member and configured for passing the commuted arcing current having the second direction, and for blocking a current having the first direction.

6. The circuit breaker according to claim 1, wherein the current-rectifying element and/or the second current-rectifying element comprise(s) a solid-state semiconductor device, in particular wherein the current-rectifying element includes a device for limiting a voltage across the semiconductor device, such as a parallel resistor or a capacitance.

7. The circuit breaker according to claim 6, wherein the current-rectifying element comprises a diode for which the forward direction is the first direction and the reverse direction is the second direction, and/or the second current-rectifying element comprises a diode for which the forward direction is the second direction and the reverse direction is the first direction.

8. The circuit breaker according to claim 6, wherein the current-rectifying element comprises a transistor such as a thyristor, in particular wherein the current-rectifying element comprises a gate switch bringing the thyristor into the blocking mode only if the arcing current is below a predetermined current threshold.

9. The circuit breaker according to claim 8, wherein the current-rectifying element comprises a pair of thyristors connected in parallel and having opposite forward directions.

10. The circuit breaker according to claim 1, further comprising an arcing chamber with splitter plates, wherein the arcing contact member is arranged such that the commuted arc traverses the arcing chamber and is split by the splitter plates.

11. The circuit breaker according to claim 1, further comprising a pair of nominal contacts with a first nominal contact member and a second nominal contact member, wherein the first and second nominal contact members are separable from each other for commuting the current to the pair of breaker contact members.

12. The circuit breaker according to claim 1, further comprising a cooling arrangement for cooling a gap which emerges between the pair of breaker contact members after separation of the pair of breaker contact members.

13. The circuit breaker according to claim 1, wherein an electrically insulated region, in particular a non-conductive gap or dielectric material, is provided between the arcing contact member and the second breaker contact member, such that the arc jumps from the second breaker contact member to the arcing contact member via the electrically insulated region.

14. The circuit breaker according to claim 1, wherein the current-rectifying element is provided in a branch which is connected parallel to a path carrying a main portion of the nominal current during normal operation.

15. A method of breaking an electrical circuit by a circuit breaker, the circuit breaker comprising a pair of breaker contact members with a first breaker contact member and a second breaker contact member, an arcing contact member, and a current-rectifying element, the method comprising:
separating the first and second breaker contact members from each other, whereby an arc develops between the first and second breaker contact members, the arc carrying an arcing current between the first and second breaker contact members;
causing an arc root to jump from the second breaker contact member to the arcing contact member, whereby the arcing current is commuted from the second breaker contact member to the arcing contact member, the commuted arcing current having a first direction;
passing the commuted arcing current through a current-rectifying element electrically connected to the arcing contact member; and
when the arcing current undergoes a zero-crossing to reverse the direction of the commuted arcing current, blocking the arcing current by the current-rectifying element.

16. The method according to claim 15, wherein the circuit breaker comprises an arc-moving arrangement for moving the arc root from the second breaker contact member to the arcing contact member, wherein the arc-moving arrangement comprises at least one of the following (i) (v):
(i) a magnetic field generator for generating a magnetic field moving the arc root to the arcing contact member by a Lorentz force;
(ii) a contact-moving device for moving at least one of the first breaker contact member, the second breaker contact member and the arcing contact member in such a manner that the distance between the first breaker contact member and the arcing contact member becomes shorter than the distance between the first breaker contact member and the second breaker contact member;
(iii) a pressure gradient generating device for generating a pressure gradient pushing the arc towards the arcing contact member;
(iv) a gas-blowing arrangement for blowing a gas stream onto the arc, the gas stream pushing the arc towards the arcing contact member;
(v) a high-voltage discharge arrangement coupled to the arcing contact member for inducing a high-voltage discharge at the arcing contact member.

17. The circuit breaker according to claim 7, wherein the current-rectifying element comprises a transistor such as a thyristor, in particular wherein the current-rectifying element comprises a gate switch bringing the thyristor into the blocking mode only if the arcing current is below a predetermined current threshold.

18. The circuit breaker according to claim 17, wherein the current-rectifying element comprises a pair of thyristors connected in parallel and having opposite forward directions.
